(19) United States
(12) Patent Application Publication
(10) Pub. No.: US 2019/0025535 A1
(43) Pub. Date: Jan. 24, 2019

(54) OPTICAL FIBER DROP CABLE

(71) Applicant: CORNING OPTICAL FIBER CABLE (CHENGDU) CO. LTD., Chengdu (CN)

(72) Inventors: Changliang Li, Tianjin (CN); Chengdong Wei, Chengdu (CN)

(21) Appl. No.: 16/139,597

(22) Filed: Sep. 24, 2018

Related U.S. Application Data
(63) Continuation of application No. PCT/CN2016/077987, filed on Mar. 31, 2016.

(51) Int. Cl. G02B 6/44

(52) U.S. Cl. CPC G02B 6/4495; G02B 6/4494; G02B 6/441; G02B 6/4433

(57) ABSTRACT

The present application discloses an optical fiber drop cable that comprises a strength member, at least two loose tubes and a cable jacket. The strength member and the at least two loose tubes are embedded within the cable jacket and the at least two loose tubes are disposed at the two opposite lateral sides of the strength member within the jacket. The strength member is adhered with the cable jacket as one piece to prevent the at least two loose tubes from twisting around or over the strength member during production, transportation and installation.

### CROSS-REFERENCE TO RELATED APPLICATION

This application is a continuation of International Application No. PCT/CN2016/077987, filed on Mar. 31, 2016, and is incorporated herein by reference.

### TECHNICAL FIELD OF THE INVENTION

The present invention relates to an optical fiber drop cable suitable for routing optical fibers towards subscribers, such as for routing the optical fibers to customer premises.

### BACKGROUND OF THE INVENTION

As known in the art, service providers such as telephone service providers or cable service providers) use optical fiber access distribution cables to transmit signals from optical fiber communication networks. Usually, optical fiber drop cables are used to route optical fiber access distribution cables (usually after it is split at a splice point) into customer premises (such as individual buildings or homes). An optical fiber drop cable may include multiple optical fibers within it. Frequently, after entering a building, each of the multiple optical fibers in an optical fiber drop cable may be further split into multiple branching connections so as to route the optical fibers to multiple connection points in a customer premise. Such a distributed splitter scheme is advantageous to reduce overall costs as it reduces the number of fiber cables deployed and size of connecting components to be used.

While the existing optical fiber drop cables can meet the needs in field installation, they have some shortcomings to route optical fiber access distribution cables to customer premises, especially when the networking infrastructure in customer premises require increasing high bandwidth and more numbers of branch points to be connected to optical fiber communication networks, but have more congested conduit spaces because of their size and lacking sufficient flexibility.

Therefore, there is a need to provide improved optical fiber drop cables that overcome the shortcomings in the existing optical fiber drop cables with better performance for deploying and installing the same within increasingly congested conduit spaces, but with increasingly needs for branch points.

### SUMMARY OF THE INVENTION

To overcome the above-mentioned shortcomings in the existing optical fiber drop cables, the present application provides an optical fiber drop cable having a strength member; at least two loose tubes; and a jacket; wherein the strength member and the at least two loose tubes are embedded within the jacket, wherein the at least two loose tubes are disposed at the two opposite lateral sides of the strength member within the jacket.

The optical fiber drop cable of the present application has a surface on the strength member which includes mechanism to increase friction between an exterior surface of the strength member and an interior of the jacket. In the optical fiber drop cable of the present application, the mechanism includes grooves, notches and/or uneven surfaces.

The optical fiber drop cable of the present application, further comprises a layer of adhesive material disposed around the exterior surface of the strength member to non-separably attach the exterior surface of the strength member onto the interior of the jacket to prevent jacket shrink and prevent the at least two loose tubes from twisting around the strength member during production, transportation and installation process. In the optical fiber drop cable of the present application, the shell or sheath of each of the at least two loose tubes is separably surrounded or attached by the jacket so that the loose tubes can be readily separated from the jacket during installation process.

In summary, the present application discloses an optical fiber drop cable that comprises a strength member, at least two loose tubes and a cable jacket. The strength member and the at least two loose tubes are embedded within the cable jacket and the at least two loose tubes are disposed at the two opposite sides of the strength member within the jacket. The strength member is adhered with the cable jacket as one piece to prevent the least two loose tubes from twisting around or over the strength member in production, transportation and installation.

The drop cables of the present application have advantages over the existing drop cable as follows:

1. The drop cables of the present application have excellent performance against cable twist during production, transportation and field installation process because the strength member and the cable jacket are strongly adhered together as one piece, which can provide improved smoothness of the drop cables in production, transportation and field installation;

2, The drop cables of the present application are more flexible, especially along its major dimension; which makes the drop cables suitable for installation in congested conduit spaces;

3. The drop cables of the present application may increase communication capacities without increasing the size of the drop cable; and

4. The drop cables of the present application can maintain communication capacities with reduced size of the drop cable.

### BRIEF DESCRIPTION OF THE DRAWINGS

The present invention will be described with reference to the accompanying drawings, wherein:

FIG. 1 depicts an existing drop cable 100;

FIG. 2 depicts a drop cable 200 according to one embodiment of the present application;

FIG. 3 depicts a drop cable 300 according to another embodiment of the present application;

FIG. 4 depicts a perspective view of the drop cable 200 shown in FIG. 2;

FIG. 5 depicts a perspective view of the drop cable 300 shown in FIG. 3;

FIG. 6 depicts a cross-sectional view of the strength member 222 in FIG. 2 to show a mechanism, which increases the attachment strength (or effectiveness) between the exterior surface of the strength member 222 in the drop cable 200 and interior of the cable jacket 226;

FIG. 7 depicts a cross-sectional view of the strength member 322 in FIG. 3 to show a mechanism, which increases the attachment strength (or effectiveness) between the exterior surface of the strength member 322 in the drop cable 300 and interior of the cable jacket 326;

FIG. 8 depicts a perspective view of the strength member 222 in FIG. 2 to show a mechanism on the strength member 222, which further increases the attachment strength (or effectiveness) between the exterior surface of the strength member 222 in the drop cable 200 and interior of the cable jacket 226;

FIG. 9 depicts a perspective view of the strength member 322 in FIG. 3 to show a mechanism on the strength member 322, which further increases the attachment effectiveness between the exterior surface of the strength member 322 in the drop cable 300 and interior of the cable jacket 326;

FIG. 10 depicts a prospective view of the strength member 222 in FIG. 2; and

FIG. 11 depicts a prospective view of the strength member 322 in FIG. 3.

### DETAILED DESCRIPTION OF THE EMBODIMENTS

Reference is now made to the embodiments, examples of which are illustrated in the accompanying drawings. In the detailed description of the embodiments, directional terminology may be used with reference to the orientation of the Figure(s) being described. Because components of embodiments of present invention can be positioned in a number of different orientations, the directional terminology is used for purposes of illustration and is in no way limiting. Whenever possible, the same reference numbers will be used throughout the drawings to refer to the same or like parts.

FIG. 1 depicts an existing drop cable 100. As shown in FIG. 1, the existing drop cable 100 includes a flat-shaped cable jacket 126 with a major dimension and a minor dimension. The existing drop cable 100 further includes two strength members 122.1 and 122.2, a loose tube 124 (typically with each including 12 optic fibers) and a water block yarn 134. The loose tube 124 is placed between the two strength members 122.1 and 122.2, and the water block yarn 134 is placed between the loose tube 124 and one of the two strength members 122.1 or 122.2. The two strength members 122.1 and 122.2, the loose tube 124 and the water block yarn 134 are round-shaped and are embedded within the cable jacket 126 along its major dimension. The loose tube 124 in the existing drop cable 100 includes a shell or sheath 132, which contains 12 fibers. In FIG. 1, the major dimension and the minor dimension of the drop cable 100 are typically 8 mm and 4 mm, respectively.

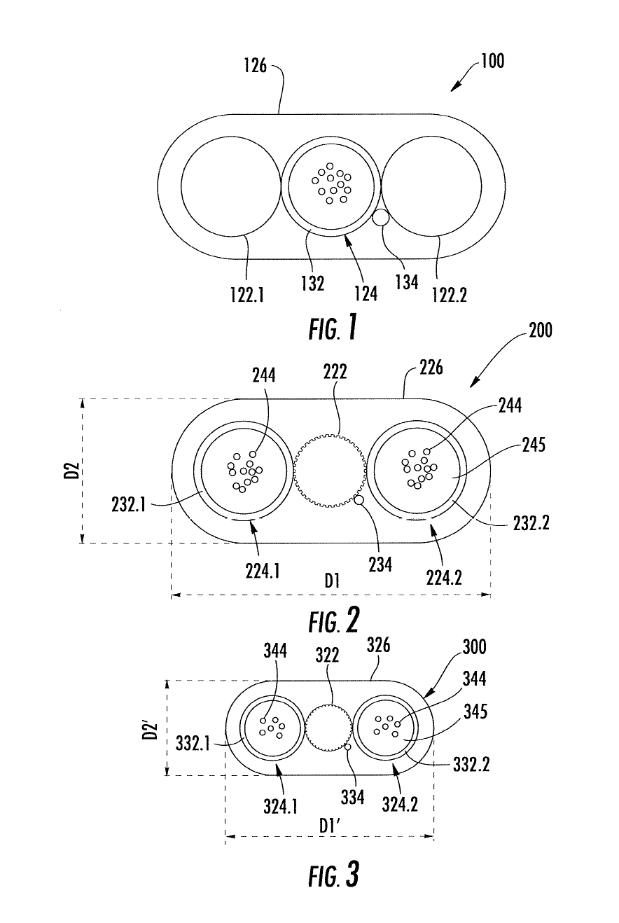

FIG. 2 depicts a drop cable 200 according to one embodiment of the present application. As shown in FIG. 2, the drop cable 200 includes a flat-shaped (or rectangular-shaped) cable jacket 226 with a major dimension D1 of 6-7 mm and a minor dimension D2. The drop cable 200 further includes a strength member 222, two (or at least two) loose tubes (224.1, 224.2) and a water block yarn 234. The two (or at least two) loose tubes 224.1 and 224.2 are placed (or disposed) at the two opposite lateral sides of the strength member 222 (or the strength member 222 is placed between the two loose tubes 224.1 and 224.2). The water block yarn 234 contains Super Absorption Powder (SAP), which can swell if meet any water (or moisture) to prevent water penetration through gap between strength member 222 and cable jacket 226 while test or cable broken. As one embodiment, the water block yarn 234 is placed (or disposed) between the strength member 222 and one of the two loose tubes (224.1 or 224.2). The strength members 222, the two (or at least two) loose tubes (224.1, 224.2) and the water block yarn 234, which can be round-shaped, are embedded within the cable jacket 226 in parallel along the major dimension D1. As one embodiment, the two (or at least two) loose tubes 224.1 and 224.2 are placed (or disposed) in contact with the two opposite lateral sides of the strength member 222 and the water block yarn 234 also in contact with the strength member 222.

In FIG. 2, each of the two loose tubes 224.1 and 224.2 encloses (or contains) one or more (typically 12) optic fibers 244, which are surrounded by filling compound 245 within the loose tube (224.1 or 224.2), The filling compound 245 can be paraffin based non-hygroscope, non-nutritive fungus, electrically non-conductive, homogenous gel to prevent water penetration and migration. Each of the two loose tubes 224.1 and 224.2 provides mechanical protection to the one or more optic fibers 244. As one embodiment, each of the two loose tubes (224.1 or 224.2) encloses (or contains) 12 optic fibers 244. To perform different functions, the cable jacket 226 is made from PE material, the strength member 222 is made from glass fiber, the shell or outer sheath (232.1 or 232.2) of the at least two loose tubes (224.1 or 224.2) is made from flexible (or bendable) plastic material. The water block yarn 234 is made from Super Absorption Powder (SAP). Because strength member 222 is made from glass fiber, it can have a desired tensile rating to withstand a predetermined tensile load for the optic fiber drop cable 200 while still maintaining a relatively small cross-sectional footprint (or profile) of the optic fiber drop cable 200. Therefore, each of the at least two loose tubes (224.1, 224.2) is more flexible than the strength member 222, or the strength member 222 has greater hardness than that of each of the at least two loose tubes (224.1, 224.2).

In the drop cable 200, the diameter of the strength member 222 is selected based on the maximum tension allowed, maximum cable elongation and Yang's modulus of the strength member 222. In the embodiment as shown in FIG. 2 when each of the two loose tubes (224.1, 224.2) encloses (or contains) 12 optical fibers, the diameter of each of the two loose tubes (224.1, 224.2) is 2.6 mm; the diameter of the strength member 222 is 2.5 mm; the dimension of the water block yarn 234 is 0.2 mm×1.0 mm. In accumulation, the major dimension D1 and the minor dimension D2 of the drop cable 200 are 8-9.5 mm and 4.0 mm, respectively.

Comparing with the existing drop cable 100, the drop cable 200 of the present application encloses (or contains) total 24 fibers, which doubles the capacity of that in the existing drop cable 100. However, the size of the drop cable 200 is no greater or slightly greater than that of the existing drop cable 100 because one strength member is omitted in the drop cable 200. In addition, because the drop cable 200 of the present application has only one strength member 222, it is more flexible along its major dimension than the existing drop cable 100 even if the drop cable 200 of the present application has a slight larger major dimension than the existing drop cable 100. More-flexibility along the major dimension of a drop cable is very desirable in filed installation process, especially in more congested conduit spaces or limited conduit spaces.

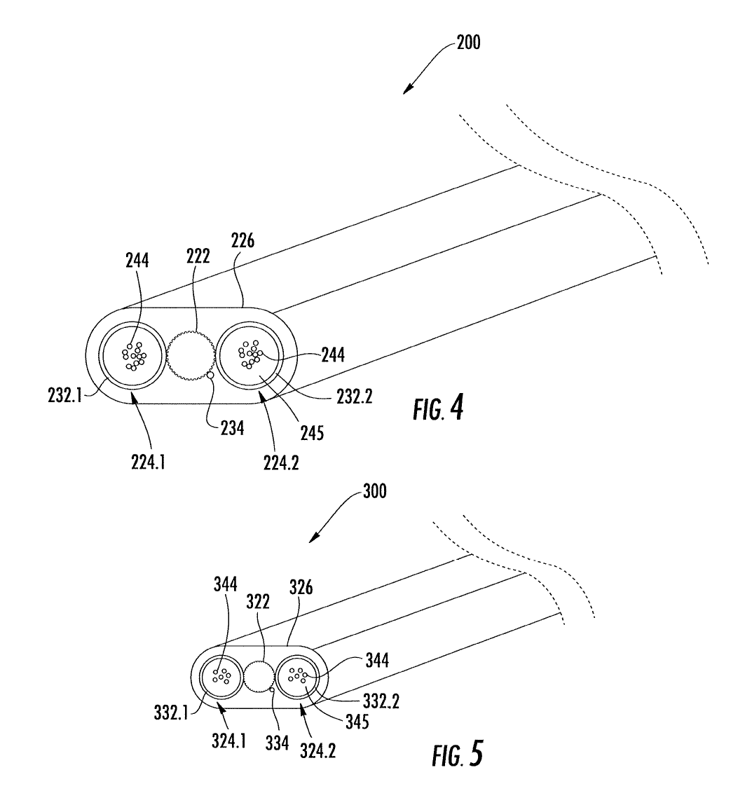

FIG. 3 depicts a drop cable 300, which has a similar structure as that shown in FIG. 2, according to another embodiment of the present application. As shown in FIG. 3, the drop cable 300 includes a flat-shaped (or rectangular-shaped) cable jacket 326 with a major dimension D1′ of 5-6 mm and a minor dimension D2′ of 3-4 mm. The drop cable 300 further includes a strength member 322, two (or at least two) loose tubes (324.1, 324.2) and a water block yarn 334. The two (or at least two) loose tubes 324.1 and 324.2 are placed (or disposed) at the two opposite lateral sides of the strength member 322 (or the strength member 322 is placed or disposed between the two loose tubes 324.1 and 324.2). To perform the function of water block in the gaps between strength member and tubes, the water block yarn 334 is wrapped around the strength member 322. The strength members 322, the two (or at least two) loose tubes (324.1, 324.2) and the water block yarn 334 can be round-shaped and are embedded within the cable jacket 326 in parallel along the major dimension D1′. As one embodiment, the two (or at least two) loose tubes 324.1 and 324.2 are placed (or disposed) in contact with the two opposite lateral sides of the strength member 322 and the water block yarn 334 also in contact with the strength member 322.

In FIG. 3, each of the two loose tubes 324.1 and 324.2 encloses (or contains) one or more (typically 6) optic fibers 344, which are surrounded by filling compound 345 within the loose tube (324.1 or 324.2). The filling compound 345 in the drop cable 300 can be the same material as that in the drop cable 200. Each of the two loose tubes 324.1 and 324.2 provides mechanical protection to the one or more optic fibers 344. As another embodiment of the present application, each of the two loose tubes (324.1 or 324.2) encloses (or contains) 6 optic fibers 344. To perform different functions, the cable jacket 326 is made from PE material, the strength member 322 is made from glass fiber, the shell or sheath (332.1 or 332.2) of the at least two loose tubes (324.1 or 324.2) is made from flexible (or bendable) plastic material, and the water block yarn 334 is made from Polyester and Super Absorption Powder.

Because the strength member 322 is made from glass fiber, it can have a desired tensile rating to withstand a predetermined tensile load for the fiber optic drop cable 300 while still maintaining a relatively small cross-sectional footprint (or profile) of the optical fiber drop cable 300. Therefore, each of the at least two loose tubes (324.1, 324.2) is more flexible than the strength member 322, or the strength member 322 has greater hardness than that of each of the at least two loose tubes (324.1, 324.2).

Similar to the considerations in the drop cable 200 shown in FIG. 2, in the drop cable 300, the diameter of the strength member 322 is selected based on Glass Reinforced Plastic. In the embodiment as shown in FIG. 3 when each of the two loose tubes (324.1, 324.2) contains 6 optical fibers, the diameter in each of the two loose tubes (324.1, 324.2) is 2.0 mm; the diameter of the strength member 322 is 2.0 mm; the dimension of the water block yarn 334 is 0.2 mm×1.0 mm. In accumulation, the major dimension D1′ and the minor dimension D2′ of the drop cable 300 can be 7.8 mm and 3.5 mm, respectively.

Comparing with the existing drop cable 100, the drop cable 300 of the present application encloses (or contains) total 12 fibers, which has the same capacity to that in the existing drop cable 100. However, because each of the two loose tubes (324.1, 324.2) encloses (or contains) 6 optical fibers, the size of each of the two loose tubes (324.1, 324.2) is smaller than the loose tubes in the drop cable 100 and 200, which enables the size of the drop cable 300 to be smaller than that of the existing drop cable 100 and that of the drop cable 200 in its major dimension and/or minor dimension. Specifically, the major dimension D1′ of the drop cable 300 is smaller than both the major dimension D1 of the drop cable 200 and the major dimension of the existing drop cable 100, while the minor dimension D2′ of the drop cable 300 is smaller than both the minor dimension D2 of the drop cable 200 and the minor dimension of the existing drop cable 100. Comparing with the drop cable 300 with the drop cable 100 shown in FIG. 1, in addition to reducing the two strength members (122.1 and 122.1) in the drop cable 100 into one strength member 322, the drop cable 300 in FIG. 3 reduces the diameters of the at least two loose tubes (324.1, 324.2), which increases additional flexibility of the drop cable 300, especially along its major dimension Dr. Additional-flexibility along major dimension of a drop cable is very desirable in filed installation process, especially in more congested conduit spaces or limited conduit spaces.

FIG. 4 depicts a perspective view of the drop cable 200 shown in FIG. 2. As shown in FIG. 4, the drop cable 200 extends along its longitude direction so that it can be assembled into connectors and used to route fiber optic access distribution cables into customer premises.

FIG. 5 depicts a perspective view of the drop cable 300 shown in FIG. 3. As shown in FIG. 5, the drop cable 300 extends along its length direction so that it can be assembled into connectors and used to route fiber optic access distribution cables into customer premises.

After long time observation and experiment, the inventors of the present application become realized that, in the structures as shown in FIG. 2 or FIG. 3 where the two loose tubes (224.1, 224.2; 324.1, 324.2) are placed (or disposed) at the two opposite lateral sides of the strength member (222; 322) in parallel along the major dimension (D1 or D1′), each of the two loose tubes (224.1, 224.2; 324.1, 324.2) may twist around (or cross over) the strength member (222; 322) in production, transportation or filed installation process if the strength member (222; 322) is loosely adhered to the interior of the cable jacket (226; 326). This is so because each of the two loose tubes (224.1, 224.2; 324.1, 324.2) is more flexible than the strength member (222; 322), or the strength member (222; 322) has greater hardness (stiffness) than that of each of the at least two loose tubes (224.1, 224.2; 324.1, 324.2).

To prevent the two loose tubes (224.1, 224.2; or 324.1, 324.2) from twisting around (or crossing over) the strength member (222; or 322) in transportation or filed installation process, in the present application, the exterior surface of the strength member (224.1, 224.2; 324.1, 324.2) is non-detachably (or non-separably) adhered (or attached) onto the interior of the cable jacket (226; 326). For that purpose, the strength member (222; 322) shown in FIG. 2 or FIG. 3 has a mechanism, which increases the friction on the exterior surface of the strength member (222; 322) in the drop cable 200 or the drop cable 300 to facilitate non-detachably (or non-separably) adhering (or attaching) the exterior surface of the strength member (222; 322) onto the interior of the cable jacket (226; 326) in cable extrusion process. As one embodiment, the exterior surface of the strength member (222; 322) includes a plurality of notches or grooves (0.15 mm for example) so that in the extrusion process the interior of the cable jacket (226; 326) can be more effectively adhered (or attached) to the exterior surface of the strength member (222; 322).

To facilitate field installation, the exterior surfaces of the two loose tubes (224.1, 224.2; 324.1, 324.2) are smooth (or relatively smooth) to facilitate detachably (or separably) adhering (or attaching) the exterior surfaces of the two loose tubes (224.1, 224.2; 324.1, 324.2) onto the interior of the cable jacket (226; 326) in cable extrusion process. In field installation, the two loose tubes (224.1, 224.2; 324.1, 324.2) can be readily (or easily) peered off from the cable jacket by using a predetermined separation force.

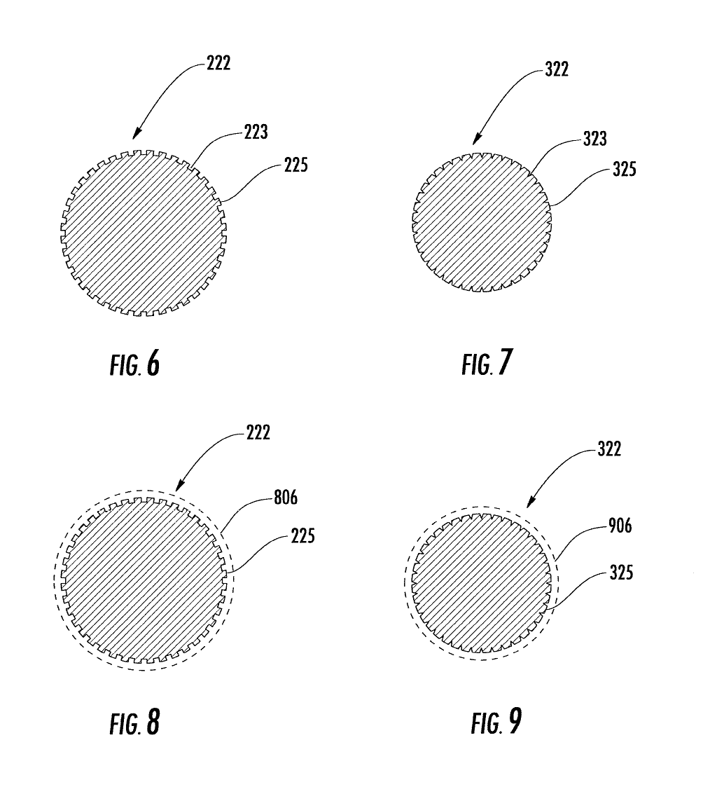

FIG. 6 depicts a cross-sectional view of the strength member 222 in FIG. 2 to show a mechanism, which increases the attachment effectiveness between the exterior surface of the strength member 222 in the drop cable 200 and interior of the cable jacket 226. As shown in FIG. 6, the strength member 222 in the drop cable 200 has a plurality of notches or grooves 223 on its exterior surface 225.

FIG. 7 depicts a cross-sectional view of the strength member 322 in FIG. 3 to show a mechanism, which increases the attachment strength (or effectiveness) between the exterior surface of the strength member 322 in the drop cable 300 and interior of the cable jacket 326. As shown in FIG. 7, the strength member 322 in the drop cable 300 has a plurality of notches or grooves 323 on its exterior surface 325.

FIG. 8 depicts a perspective view of the strength member 222 in FIG. 2 to show a mechanism on the strength member 222, which further increases the attachment strength (or effectiveness) between the exterior surface of the strength member 222 in the drop cable 200 and interior of the cable jacket 226. As shown in FIG. 8, the strength member 222 is coated with a layer of adhesive 806 on its exterior surface 225, which can be heating-melt glue.

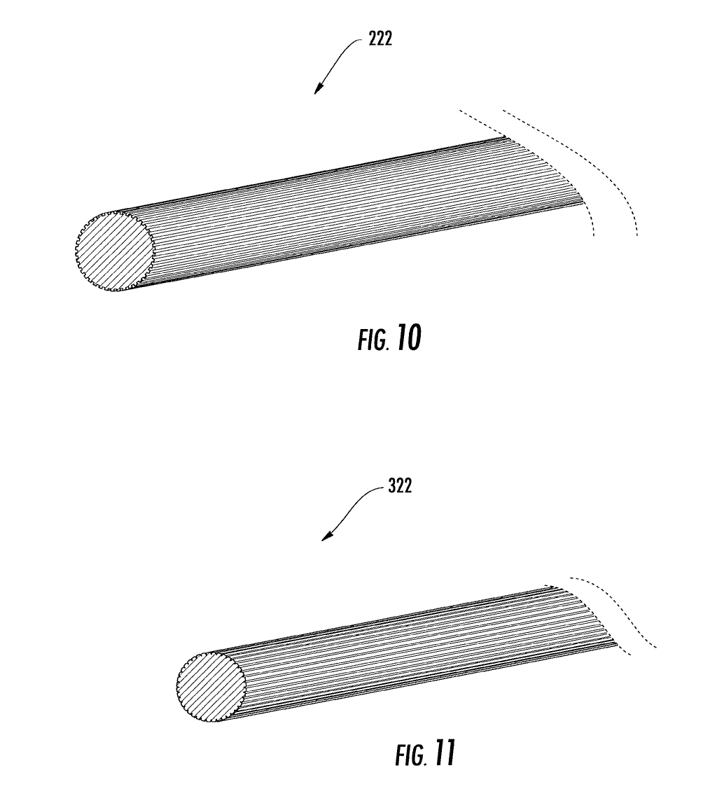

FIG. 9 depicts a perspective view of the strength member 322 in FIG. 3 to show a mechanism on the strength member 322, which further increases the attachment strength (or effectiveness) between the exterior surface of the strength member 322 in the drop cable 300 and interior of the cable jacket 326. As shown in FIG. 9, the strength member 322 is coated with a layer of adhesive 906 on its exterior surface 325, which can be hot-melt glue.

In manufacturing process for the drop cable 200 in FIG. 2 (or the drop cable 300 in FIG. 3), the two loose tubes (224.1, 224.2; 324.1, 324.2), the strength member (222; 322) and water block yarn (234; 334) are fed into PE extruding machine (not shown), which has an extruding chamber having the cross-sectional shape identical to that of the drop cable (200; 300). In extruding process, the PE material pellets in the extruding chamber are being melted by means of squeezing force within the extruding chamber. In turn, the hot-melt glue in the adhesive layer (806; 906) is being melt and the notches or grooves (223; 323) on the exterior surface (225; 325) of the strength member (222; 322) are filled with melt glue and melt PE material within the extruding chamber. After the two loose tubes (224.1, 224.2; 324.1, 324.2), the strength member (222; 322) and water block yarn (234; 334) are being pulled out of the PE extruding machine, a layer of hot (or warm) PE material is (separably) surrounded or attached the two loose tubes (224.1, 224.2; 324.1, 324.2), the strength member (222; 322) and water block yarn (234; 334). After cooling down, the hot-melt glue in the adhesive layer (806; 906) returns to solid state and the layer of PE material becomes firm to form the drop cable (200; 300) with the flat-shaped (or rectangular-shaped) cable jacket (226; 326). The exterior surface of the strength member (222; 322) is strongly adhered (or attached) onto the interior of the cable jacket (226; 326) due to the hot-melt glue on the surface of the strength member (222; 322) and the notches or grooves (223; 323) on the surface of the strength member (222; 322). During extruding process, because each of the two loose tubes (224.1, 224.2; 324.1, 324.2) has a smooth surface, the exterior surface of each of the two loose tubes (224.1, 224.2; 324.1, 324.2) is detachably (or separately) adhered onto the interior of the cable jacket (226; 326) if the temperature of the melt PE material in the extruding chamber is selected not to melt the shell or sheath of the two loose tubes (224.1, 224.2; 324.1, 324.2).

In field installation process, the cable jacket (226; 326) can be readily (or easily) peered off from the two loose tubes (224.1, 224.2; 324.1, 324.2) by excreting a predetermined (or customarily used) separation force. However, the same predetermined (or customarily used) separation force (even a separation force that is larger than the predetermined force) is not able to detach or separate the cable jacket (226; 326) off the strength member (222; 322) because of the notches or grooves (223; 323) on the exterior surface of the strength member (222; 322) and the glue around the strength member (222; 322).

In the production, transportation or field installation process, even the drop cable 200 or 300 is twisted or in twisted position, the two loose tubes (224.1, 224.2; 324.1, 324.2) cannot twist around or over the strength member (222; 322) inside of the cable jacket (226; 326) because the surface of the strength member (222; 322) is non-detachably (or non-separately) adhered to the interior of the cable jacket (226; 326) so that the strength member (222; 322) and the cable jacket (226; 326) are adhered as one piece. The adherence between the exterior surface of the strength member (222; 322) and the interior of the cable jacket (226; 326) is strong enough so that the twist force around the strength member (222; 322) by the two loose tubes (224.1, 224.2; 324.1, 324.2) cannot separate the strength member (222; 322) from the cable jacket (226; 326).

FIG. 10 depicts a prospective view of the strength member in FIG. 2, which extends along the longitude direction of the strength member 222.

FIG. 11 depicts a prospective view of the strength member 322 in FIG. 3, which extends along the longitude direction of the strength member 322.

The drop cable 200 or 300 in the present application has the advantageous technical effects as follows:

1. Comparing with the existing drop cable that has two strength members shown in FIG. 1, the drop cable 200 or 300 has excellent performance against cable twist during production, transportation and field installation process because the strength member and the cable jacket are strongly adhered together as one piece, which can provide improved smoothness of the drop cable 200 or 300 in production, transportation and field installation;

2. Comparing with the existing drop cable that has two strength members shown in FIG. 1, the drop cable 200 or 300 is more flexible, especially along its major dimension, which makes the drop cable 200 or 300 suitable for installation in congested conduit spaces; and

3. Comparing with the existing drop cable that has two strength members shown in FIG. 1, the drop cable 200 increases communication capacities without increasing the size of the drop cable. In FIG. 3, the drop cable 300 has smaller size without reducing communication capacities. Therefore, the drop cable 200 or 300 reduces manufacturing costs of the drop cable 200 or 300. In addition, the compact size of the drop cable 200 or 300 makes the drop cable 200 or 300 more flexible and more suitable in congested conduit spaces, especially in a need to pass the drop cable 200 or 300 through a tube in filed installation.

It will be apparent to those skilled in the art that various modifications and variations can be made to the embodiments described herein without departing from the spirit and scope of the claimed subject matter. Thus, it is intended that the specification cover the modifications and variations of the various embodiments described herein, provided such modification and variations come within the scope of the appended claims and their equivalents.

1. An optical fiber drop cable, comprising:
a strength member;
at least two loose tubes; and
a jacket;
wherein the strength member and the at least two loose tubes are embedded within the jacket,
wherein the at least two loose tubes are disposed at the two opposite lateral sides of the strength member within the jacket.

2. The optical fiber drop cable of claim 1, wherein:
the drop cable has a major dimension and a minor dimension, and
the jacket is flat-shaped along the major dimension of the drop cable.

3. The optical fiber drop cable of claim 2, wherein:
each of the at least two loose tubes is more flexible than the strength member, or
the strength member has greater hardness (or stiffness) than that of each of the at least two loose tubes.

4. The optical fiber drop cable of claim 3, wherein:
the strength member is a glass fiber rod made from glass fiber,
the jacket is made from PE material, and
each of the two loose tubes has a shell or sheath, wherein the shell or sheath of the at least two loose tubes is made from plastic material.

5. The optical fiber drop cable of claim 1, wherein:
each of the at least two loose tubes includes a shell or sheath in which a plurality of optical fibers are accommodated.

6. The optical fiber drop cable of claim 5, wherein:
the at least two loose tubes are two loose tubes,
each of the two loose tubes contains 2 to 12 fibers.

7. The optical fiber drop cable of claim 6, wherein:
the drop cable has a major dimension size with a range of 7 to 9.5 mm and a minor size with a range of 3 to 5 mm.

8. The optical fiber drop cable of claim 5, wherein:
the at least two loose tubes are two loose tubes,
each of the two loose tubes contains 2 to 6 fibers.

9. The optical fiber drop cable of claim 8, wherein:
the drop cable has a major dimension size Ti a range of 5 to 8 mm and a minor size with a range of 2 to 4 mm.

10. The optical fiber drop cable of claim 1, further comprising:
a water block yarn.

11. The optical fiber drop cable of claim 10, wherein:
the water block yarn rotates around the strength member.

12. The optical fiber drop cable of claim 1, wherein:
an exterior surface of the strength member includes a mechanism to increase friction between the exterior surface of the strength member and an interior of the jacket.

13. The optical fiber drop cable of claim 12, wherein:
the mechanism includes grooves, notches and/or uneven surfaces.

14. The optical fiber drop cable of claim 13, further comprising:
a layer of adhesive material disposed around the exterior surface of the strength member to non-separably attach the exterior surface of the strength member onto the interior of the jacket to prevent the at least two loose tubes from twisting around the strength member during production, transportation and installation process.

15. The optical fiber drop cable of claim 14, wherein:
the layer of adhesive material is melted during extension to adhere or attach the exterior surface of the strength member with the interior of the jacket.

16. The optical fiber drop cable of claim 15, wherein:
the layer of adhesive material adheres or attaches the exterior surface of the strength member onto the interior of the jacket so that the exterior surface of the strength member and the interior of the jacket become one piece.
